(19) United States
(12) Patent Application Publication
(10) Pub. No.: US 2022/0081341 A1
(43) Pub. Date: Mar. 17, 2022

(54) METHOD FOR MANUFACTURING HOLLOW GLASS, AND HOLLOW GLASS

(71) Applicant: Yazaki Energy System Corporation, Tokyo (JP)

(72) Inventor: Takuju Nakamura, Tokyo (JP)

(73) Assignee: Yazaki Energy System Corporation, Tokyo (JP)

(21) Appl. No.: 17/537,031

(22) Filed: Nov. 29, 2021

Related U.S. Application Data
(63) Continuation of application No. PCT/JP2020/020139, filed on May 21, 2020.

(30) Foreign Application Priority Data
May 30, 2019 (JP) 2019-101029

(51) Int. Cl. C03B 23/24; C03B 23/03

(52) U.S. Cl. CPC C03B 23/245; C03B 23/03

(57) ABSTRACT

Plate glasses of the same material are stacked each other to form a hollow portion between the plate glasses. The stacked plate glasses are heated to a temperature which is a softening point thereof or below and is a temperature or above at which the material can be diffusion-bonded at a predetermined pressure or higher. The heated and stacked plate glasses are pressed to a predetermined pressure or higher using a die. Together with or subsequent to the pressing, a gas pressure is applied into the hollow portion by feeding gas into the hollow portion. Next, the stacked plate glasses, in which the gas pressure is applied to the hollow portion, are cooled to the strain point while being held with the die.

### CROSS REFERENCE TO RELATED APPLICATIONS

This application is a continuation application of International Application No. PCT/JP2020/020139, now WO 2020/241450 A1, filed on May 21, 2020, which claims priority to Japanese Patent Application No. 2019-101029, filed on May 30, 2019, the entire contents of which are incorporated by reference herein.

### BACKGROUND

### 1. Technical Field

The present invention relates to a method for manufacturing a hollow glass and to a hollow glass.

### 2. Description of the Related Art

A hollow glass, which is proposed in JP 2017-043054 A1 (Patent Literature 1), includes two plate glasses and a member. The member constitutes a frame body or the like provided at the peripheral ends of the two plate glasses. The two plate glasses are stacked through the member constituting the frame body or the like. With this lamination, a hollow portion is formed between the two plate glasses. The hollow portion is maintained in a vacuum, for example. Further, Patent Literature 1 proposes to provide a low-melting-point glass such as frit glass at the peripheral ends of the two plate glasses. Since the melting point of low-melting-point glass is lower than that of the two plate glasses, the two plate glasses are fused to each other by melting only the low-melting-point glass. Compared with the hollow glass using the member constituting the frame body or the like, the hollow glass using the low-melting-point glass is less likely to allow external air to enter the hollow portion through a gap between the member and the plate glass.

### SUMMARY

Generally, the low-melting-point glass such as the frit glass is very expensive. Therefore, the use of the low-melting-point glass comes to increase the cost of the hollow glass. Instead of the low-melting-point glass such as the frit glass, it can be considered to perform fusion bonding with a low-melting-point metal. However, the low-melting-point metal is also expensive, and it also increases the cost of the hollow glass. When the low-melting-point metal is used, the low-melting-point metal is fused to the glass. In this regard, it likely causes cracking while being cooled after the fusion bonding. That is, there is room for improvement in terms of sealability due to the occurrence of cracks and the like.

The present invention has been made considering the above circumstances, and the object is to provide a hollow glass and a method for manufacturing the hollow glass, which are capable of reducing the cost and improving the sealability.

A method for manufacturing a hollow glass according to the present invention, includes: stacking plate glasses of the same material each other to form the hollow portion between the plate glasses; heating the stacked plate glasses to a temperature which is a softening point thereof or below and is a temperature or above at which the material can be diffusion-bonded at a predetermined pressure or higher; pressing the heated and stacked plate glasses to a predetermined pressure or higher using a die together with or subsequently applying a gas pressure into the hollow portion by feeding gas into the hollow portion; and cooling the stacked plate glasses to a strain point while the gas pressure is applied into the hollow portion and the stacked plate glasses are held with the die.

A hollow glass according to the present invention includes: at least two plate glasses; and a frame glass having a bonding portion bonded with the at least two plate glasses to form a hollow portion between the at least two plate glasses, wherein the at least two plate glasses and the frame glass are formed of the same material.

According to the present invention, it is possible to provide a hollow glass and a method for manufacturing the hollow glass, which can suppress an increase in cost and improve sealability.

### BRIEF DESCRIPTION OF THE DRAWINGS

FIG. 1 is a cross-sectional view showing an example of a hollow glass according to a first embodiment of the present invention.

FIGS. 2A to 2E is a flow sheet showing a method of manufacturing a hollow glass according to a first embodiment, wherein FIG. 2A shows a first step, FIG. 2B shows a second step, FIG. 2C shows a third step, FIG. 2D shows a fourth step, and FIG. 2E shows a fifth step.

FIG. 3 is a cross-sectional view showing an example of a hollow glass according to a second embodiment.

FIGS. 4A to 4D is a flow sheet showing steps for manufacturing the two plate glasses 21, 22, which are for forming the hollow glass shown in FIG. 3, wherein FIG. 4A is a preparation step, FIG. 4B is a heating step, FIG. 4C is a pressing step, and FIG. 4D is an annealing process.

FIGS. 5A to 5D is a flow sheet showing a method of manufacturing a hollow glass according to a second embodiment, wherein FIG. 5A shows a first step, FIG. 5B shows a second step, FIG. 5C shows a third step, and FIG. 5D shows a fourth step.

FIG. 6 is a cross-sectional view showing an example of a hollow glass according to a third embodiment.

FIGS. 7A to 7D is a flow sheet showing a method of manufacturing a hollow glass according to a third embodiment, wherein FIG. 7A shows a first step, FIG. 7B shows a second step, FIG. 7C shows a third step, and FIG. 7D shows a fourth step.

### DESCRIPTION OF THE EMBODIMENTS

Hereinafter, several embodiments according to the present invention will be described. It should be noted that the present invention is not limited to the embodiments described below, and may be appropriately modified within a range not departing from the scope of the present invention. In the embodiments described below, an illustration or explanation about some of the configurations is omitted. However, the details of the omitted techniques can apply publicly known or well-known techniques as far as there is no conflict between the contents described below and the applied techniques.

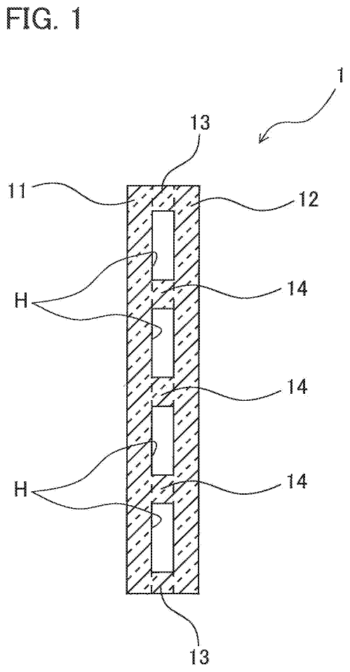

FIG. 1 is a cross-sectional view showing an example of a hollow glass 1 according to the first embodiment. The hollow glass 1 shown in FIG. 1 includes two plate glasses (sheet glasses) 11 and 12, a frame glass 13, and one or more pillar glasses 14, and further includes a hollow portion H inside the hollow glass 1. The two plate glasses 11 and 12 are formed, for example, in a flat plate shape. The frame glass 13 is positioned between the two plate glasses 11 and 12 and at the peripheral ends of them. The frame glass 13 bonds the two plate glasses 11 and 12 to each other such that they form a hollow portion H. For the convenience of explanation, the plate glass 11 may be referred to as a first plate glass and the plate glass 12 may be referred to as a second plate glass.

The pillar glasses 14 are positioned in the hollow portion H, which is formed of the plate glasses 11, 12 and the frame glass 13. The pillar glasses 14 project from one of the plate glasses 11, 12 toward the other of the plate glasses 11, 12. The pillar glasses 14 may be formed integrally with one of the two plate glasses 11, 12. In this case, the other of the two plate glasses 11 and 12 may be bonded to the pillar glasses 14 or may not be bonded. Note that the pillar glasses 14 may be formed in a point shape when viewed in a plan view of the hollow glass 1, or may be formed in a linear shape continuously formed in a predetermined direction (for example, a horizontal direction).

The two plate glasses 11 and 12, the frame glass 13 and the pillar glasses 14 are all formed of the same material. Therefore, the material of the frame glass 13 is not a so-called low-melting-point glass such as a frit glass having its melting point lower than that of the two plate glasses 11 and 12.

A pressure in the hollow portion H of the hollow glass 1 is set to a value lower than that of the atmosphere. In other words, the hollow portion H is kept in a state close to a vacuum. Therefore, the hollow glass 1 is provided with the pillar glasses 14 in the hollow portion H so that the two plate glasses 11, 12 can withstand the external pressure. The pillar glasses 14 are held between the plate glasses 11, 12 by external pressure even if it is not integrally formed with or joined to the plate glasses 11, 12. However, from the viewpoint of preventing the pillar glasses 14 from falling off, it is preferable that the pillar glasses 14 are integrally formed with or joined to at least one of the two plate glasses 11 and 12. When the hollow portion H is filled with a gas such as argon gas, the hollow glass 1 may not include the pillar glasses 14.

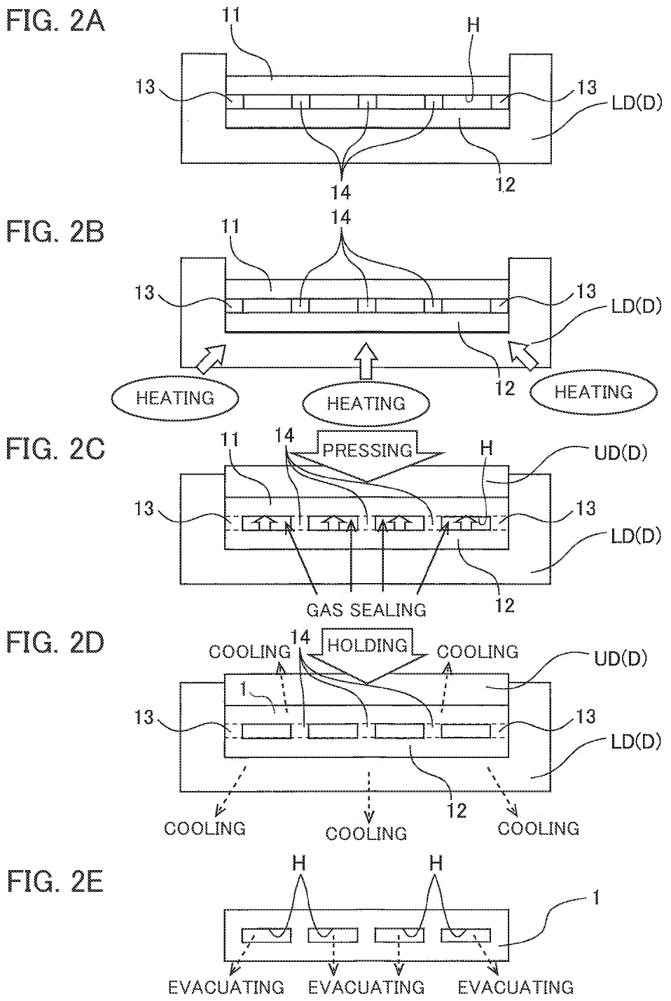

FIGS. 2A to 2E are a flow sheet showing a method of manufacturing the hollow glass 1 according to the present embodiment, wherein FIG. 2A shows a first step, FIG. 2B shows a second step, FIG. 2C shows a third step, FIG. 2D shows a fourth step, and FIG. 2E shows a fifth step.

As shown in FIG. 2A, glasses 11 to 14 are stacked in a lower die (mold) LD (first step). More specifically, the plate glasses 11, 12 and the frame glass 13 are stacked such that the hollow portion H (see FIG. 1) is formed between the two plate glasses 11, 12 formed of the same material. That is, the frame glass 13 is positioned between the two plate glasses 11, 12 to form the hollow portion H. Further, the present embodiment assumes a vacuum glass as the hollow glass 1. Therefore, the pillar glasses 14 are positioned in the hollow portion H. The shape of each pillar glass 14 is, for example, a column having a square cross section (for example, 3 mm square).

Next, as shown in FIG. 2B, the stacked glasses 11 to 14 by the first step are heated (second step). In the second step, the glasses 11 to 14 are heated to a temperature which is a softening point thereof or below and is a temperature or above at which the material constituting the glasses 11 to 14 can be diffusion-bonded at a predetermined pressure (for example, about 0.1 MPa depending on the temperature) or higher.

Thereafter, as shown in FIG. 2C, the glasses 11 to 14 heated in the second step are pressed using the upper die (mold) UD by a predetermined pressure or higher (third step). The stacked glasses 11 to 14 are diffusion-bonded and integrated in the third step.

The glasses 11 to 14 are softened by heating in the second step. Therefore, in the third step, the hollow portion H tends to be crushed by pressing. For this reason, a gas (e.g., an inert gas such as argon gas) is sealed (filled) in the hollow portion H (see FIG. 1). The sealing of the gas may be made together with pressing the glasses 11 to 14 or may be subsequently (successively) made after they are pressed. The hollow portion H does not necessarily have to be completely spatially closed. In this case, by continuously filling the gas into the hollow portion H, the hollow portion H can be maintained in a state at a higher pressure than the outside. That is, the gas pressure may be applied to the hollow portion H by continuously feeding the gas to the hollow portion H.

Next, as shown in FIG. 2D, in the fourth step, the stacked glasses 11 to 14 are cooled to the strain point while being held with the die (mold) D. The cooling here is annealing by natural cooling.

Thereafter, the hollow glass 1 is removed from the die D and further cooled outside the die D. In the fourth step, the following processes may be performed: annealing the stacked glasses 11 to 14 to remove the internal stress, thereafter rapidly heating them again to the annealing point or higher, and quenching them from the outside by water-cooling the die D while quenching them from the inside by feeding cooling air into the hollow portion H. Consequently, a physically strengthened hollow glass can be obtained.

After the hollow glass 1 is cooled, as shown in FIG. 2E, the hollow portion H of the hollow glass 1 is evacuated (fifth step). This evacuation of the fifth step is performed by using a gas filling hole (not shown) of the hollow glass 1. The gas filling hole is formed in the hollow glass 1 for sealing gas in the third step, for example. The gas filling hole (evacuation hole) is melted and sealed by a gas burner or the like after the evacuation.

The fifth step may not be performed when the hollow portion H is not evacuated. In this case, the air or the inert gas used in the third step may be left filled in the hollow portion H. Argon gas and krypton gas have about ⅔ and about ⅓ of the thermal conductivity of air, respectively. Therefore, when the gas filling hole is sealed while the argon gas is sealed in the hollow portion H, it is possible to obtain the hollow glass 1 having higher heat-insulating property than that in the case where the hollow portion H is filled with air. When the gas filling hole is sealed while the krypton gas is confined in the hollow portion H, the hollow glass 1 having further high heat-insulating property can be obtained.

In the manufacturing method according to the present embodiment, the plate glasses 11, 12 are stacked each other to form the hollow portion H, their material is heated to a temperature, which is a softening point or below and is a temperature or above at which diffusion bonding can be performed at a predetermined pressure or higher, and the stacked plate glasses 11, 12 are pressed with the die D to a predetermined pressure or higher. Therefore, it is possible to form the hollow portion H, which is surrounded by the same material, by diffusion bonding without using glass or metal having a low melting point. Further, the hollow glass 1 is cooled to the strain point while being held with the die D. Therefore, the hollow glass 1 retains the molded shape. In addition, gas is sealed in the hollow portion H when the plate glasses 11, 12 are pressed. Therefore, the hollow portion H between the heated plate glasses 11 and 12 can be prevented from being crushed. That is, according to the manufacturing method according to the present embodiment, it is possible to suppress an increase of the cost and to improve the sealability of the hollow glass.

In addition, it is possible to produce a heat-insulating vacuum glass by venting the gas sealed in the hollow portion H, which is for maintaining the shape of the hollow portion H between the plate glasses 11 and 12, and evacuating the hollow portion H.

The pillar glasses 14 are formed of the same material as the plate glasses 11, 12. The pillar glasses 14 can be integrated with the plate glasses 11 by being arranged in the hollow portion H, and performing diffusion-bonding of the glass member and the pillar glasses 14. With this, the pillar glasses 14 can be prevented from falling off from the hollow glass 1.

The hollow glass 1 includes the two plate glasses 11, 12 and the frame glass 13. The frame glass 13 has a bonding portion which is bonded with the two plate glasses 11, 12 to form the hollow portion H between the two plate glasses 11, 12. The two plate glasses 11 and 12 and the frame glass 13 are formed of the same material. Therefore, it is possible to form the hollow portion H surrounded by the same material by bonding without use of a glass and a low-melting-point metal. Accordingly, it is possible to provide a hollow glass 1, which can suppress an increase in cost and improve sealability.

It is formed of the same material as the plate glasses 11 and 12. The pillar glasses 14 are bonded (joined) to one of the plate glasses 11, 12 and protrudes from the one toward the other of the plate glasses 11, 12. The pillar glasses 14 are bonded (joined) or not bonded (joined) to the other of the plate glasses 11, 12. That is, the pillar glasses 14 are integrated with at least one of the plate glasses 21 and 22. Therefore, the pillar glasses 14 can be prevented from falling off from the hollow glass 1.

Next, a second embodiment of the present invention will be described. A hollow glass and a method of manufacturing the same according to the second embodiment differ from those of the first embodiment in a part of the structure and method. In other words, the configuration and steps according to the second embodiment are the same as those of the first embodiment except for differences from the first embodiment. The difference from the first embodiment will be described below.

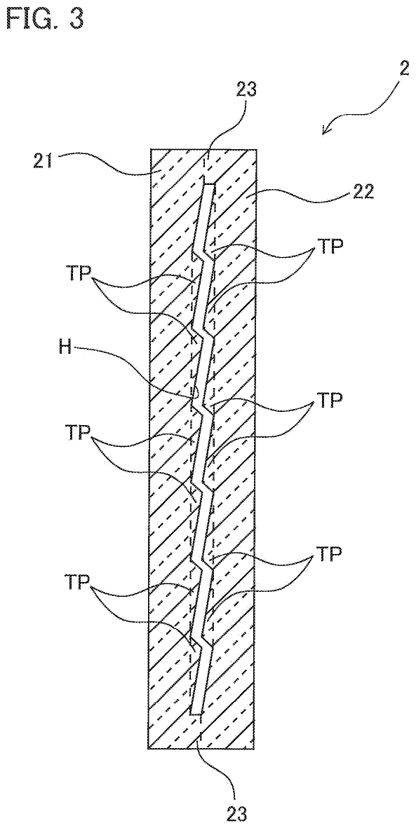

FIG. 3 is a cross-sectional view showing an example of a hollow glass 2 according to the second embodiment. Same as the first embodiment, as shown in FIG. 3, the hollow glass 2 according to the second embodiment includes two plate glasses 21 and 22, a frame glass 23, and pillar glasses (not shown). All the glasses 21 to 23 (including pillar glass) are made of the same material.

Same as the first embodiment, the hollow glass 2 also includes the pillar glasses. However, since the pillar glasses according to the second embodiment are very fine, the illustration thereof is omitted. In the second embodiment, the frame glass 23 is formed integrally with each of the two plate glasses 21, 22 in advance (i.e., integrated before diffusion bonding). For example, a part of the frame glass 23 is formed integrally with the plate glass 21 in advance, and the rest of the frame glass 23 is formed integrally with the plate glass 22 in advance. In addition, the pillar glasses of the hollow glass 2 are formed integrally with the plate glass 21 in advance. For example, the hollow glass 2 is formed by diffusion-bonding from the plate glass 21 with the pillar glasses having the frame glass 23 and the plate glass 22 without the pillar glasses having the frame glass 23.

The pillar glasses may be integrated with the plate glass 22, or may not be provided if the hollow portion H is not to be evacuated. Further, the frame glass 23 is not limited to the case where it is integrated with each of the two plate glasses 21, 22, but may be integrated with only one of them.

The hollow portion H according to the second embodiment has a space formed in a zigzag shape. That is, portions of the two plate glasses 21 and 22 facing the hollow portion H have inclined surfaces functioning as triangular prisms TP. The inclined surfaces constituting the triangular prisms TP are processed with mirror surface treatment by ceramic coating or the like depending on the use of the glass.

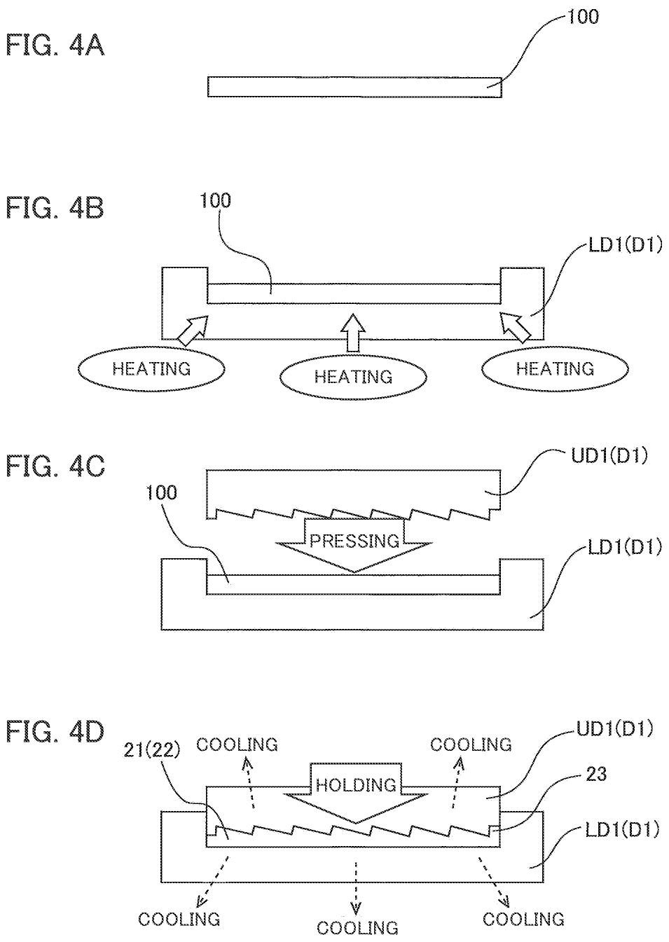

FIGS. 4A to 4D are a flow sheet showing steps for manufacturing the two plate glasses 21, 22, which are for forming the hollow glass 2 shown in FIG. 3, wherein FIG. 4A is a preparation step, FIG. 4B is a heating step, FIG. 4C is a pressing step, and FIG. 4D is an annealing process.

First, as shown in FIG. 4A, a flat plate glass 100 which is an untreated glass is prepared (preparation step). The flat plate glass 100 has the substantially same area as the hollow glass 2. However, the triangular prisms TP (see FIG. 3), the frame glass 23 (see FIG. 4D), and the pillar glasses are not yet formed on the surface of the flat plate glass 100. In the preparation step, not only the flat plate glass 100 but also a non-flat plate glass having some irregularities may be prepared. That is, in the preparation step, the untreated glass preferably has a shape as close to the final shape as possible. In the preparation step, glass, which does not require a high heating temperature as possible and does not have a relatively large thermal expansion coefficient in the below-mentioned heating step, may be selected as the untreated glass. However, glass such as the so-called blue plate or white plate made of soda lime glass, which requires a relatively high heating temperature and has a relatively large thermal expansion coefficient, may be selected.

Next, as shown in FIG. 4B, the flat plate glass 100 is heated in a state where it is mounted on the lower die (mold) LD1 (heating step). In the heating step, the flat plate glass 100 is heated to a temperature (e.g., around 690° C.), which is higher than the strain point (e.g., 500° C.) of the material of the flat plate glass 100 and lower than the softening point (e.g., 720° C.) thereof, and at which the flat plate glass 100 is deformable by being pressed at a predetermined pressure (e.g., about 2.5 MPa depending on the temperature) or higher. The flat plate glass 100 is heated such that the temperature substantially uniformly raises.

Thereafter, as shown in FIG. 4C, in a state where the flat plate glass 100 has been heated, the upper die (mold) UD1 presses the flat plate glass 100 at a predetermined pressure or higher to perform pressing (pressing step). The upper die UD1 has a die structure corresponding to the triangular prisms TP (see FIG. 3) and the frame glass 23 (see FIG. 4D). By press molding to the flat plate glass 100, the plate glasses 21 and 22 having the triangular prisms TP and the frame glass 23 are manufactured.

In the second embodiment, it is assumed that fine pillar glasses are formed on one of the plate glasses 21 and 22. The upper die UD1 forming these pillar glasses has a die structure corresponding to the pillar glasses in addition to the die structure of the triangular prisms TP and the frame glass 23. The upper die UD1 has a surface with high smoothness so that the smoothness of each surface of the triangular prisms TP (see FIG. 3) is high. This point is the same for the lower die LD1.

Next, as shown in FIG. 4D, the plate glass 21 is cooled to the strain point (for example, 500° C.) while being held by the upper die UD1 and the lower die LD1 (fourth step). Similarly, the plate glass 22 is also cooled to the strain point while being held by the upper die UD1 and the lower die LD1. The cooling here is annealing by natural cooling.

Thereafter, when the plate glass 21 (22) is annealed to the strain point, the plate glass 21 (22) is removed from the die (mold) D1 and is cooled outside the die D1.

By the above steps, the plate glasses 21 and 22 having the triangular prisms TP and the frame glass 23 (and the pillar glasses) shown in FIG. 3 are manufactured. In the manufacturing method described above, the upper die UD1 and the lower die LD1 hold the plate glasses 21 and 22 until they are cooled. Therefore, it is possible to easily form an accurate shape and to perform mirror surface treatment which can improve the smoothness. Thus, it is possible to process the mirror surface treatment to the plate glasses 21 and 22 and to form a shape with high accuracy.

When relatively large plate glasses 21 and 22 would be manufactured, the plate glasses 21 and 22 might be broken while being cooled from the heating temperature in the heating step to the strain point. For example, it is assumed that the large plate glass 21 (22) of 1 m×2 m is manufactured. In this case, if there is a difference of 2.0×10⁻⁶/K between the expansion coefficiencies of the die D1 having a length of 2 m and the plate glass 21 (22), a difference of 0.8 mm in length would be caused by cooling by about 200° C. (i.e., cooling from about 690 to 500° C.). When a difference in length exceeding this value would occur, the plate glass 21 (22) would be cracked. In particular, when the shape to be molded has a plurality of recesses or projections and the thermal expansion coefficient of the plate glass 21 (22) is larger than that of the die D1, the plate glass is likely to crack because the die D1 and the plate glass 21 (22) grip each other and tensile stress is generated in the plate glass 21 (22).

Therefore, in the pressing step according to the second embodiment, the pressing is performed with the die D1 having a predetermined thermal expansion coefficient. The predetermined thermal expansion coefficient of the die D1 is a thermal expansion coefficient in which the difference of thermal expansion coefficient of the die D1 from the thermal expansion coefficient of the plate glass 21 (22) at the strain point of the plate glass 21 (22) is 2.0×10⁻⁶/K or less in the temperature range between the molding temperature and the strain point of the plate glass. Thus, the plate glass 21 (22) can be prevented from cracking. The predetermined thermal expansion coefficient of the die D1 is preferably larger than the thermal expansion coefficient of the plate glass 21 (22) at the strain point of the plate glass 21 (22) in a range of 0 to 2.0×10⁻⁶/K in a temperature range between the molding temperature and the strain point of the plate glass 21 (22). In this case, the shrinkage amount of the die D1 while the annealing is slightly larger than the shrinkage amount of the plate glass 21 (22). Therefore, a proper range of compressive force is applied to the plate glass (22). In other words, it is possible to prevent (avoid) the tensile force, which causes cracks, from being applied to the glass, which is weak against tensile force.

Generally, a temperature of glass between a strain point thereof and a softening point thereof is referred to as a transition point. The thermal expansion coefficient drastically varies below and above the transition point. The thermal expansion coefficient is almost constant in a temperature range from room temperature to the strain point, which is lower than the transition point. However, the transition point is easily fluctuated by heat treatment or the like, and it is difficult to specify the transition point. For this reason, the specific temperature of the transition point cannot be exemplified, but the temperature in the molding according to the present embodiment is close to the softening point. Therefore, the temperature of the glass passes this transition point during annealing after molding. Since the glass has fluidity at temperatures above the transition point, cracks due to differences in thermal expansion during annealing are unlikely to occur. On the other hand, since cracks tend to occur at temperatures below the transition point, the thermal expansion coefficient of the glass at the strain point is compared with the thermal expansion coefficient of the die.

In the second embodiment, a float glass is assumed as the flat plate glass 100. The float glass is relatively inexpensive and is processed with mirror surface treatment. As the float glass, there are so-called a blue plate (blue plate glass) made of soda-lime glass and so-called a white plate (white plate glass) made with low iron content. The thermal expansion coefficients of the blue and white plates are 8.5×10⁻⁶ to 10.0×10⁻⁶/K from room temperature to the strain point, more typically 9.0×10⁻⁶ to 9.5×10⁻⁶/K. The strain point is about 450 to 520° C., and the softening point is about 690 to 730° C.

On the other hand, the thermal expansion coefficient of a general metal material of a die, which can be formed by casting, at around 500° C. is larger than that of the float glass. For example, the thermal expansion coefficient of martensitic stainless steel, which is a general die material, at around 500° C. is 13×10⁻⁶/K or more. On the contrary, when the die material would be a high-melting-point material, a combined material of materials having low miscibility (compatibility), or the like, the thermal expansion coefficient at around 500° C. is smaller than that of the float glass. For example, the thermal expansion coefficient of the cemented carbide is 7×10⁻⁶/K or less, and the thermal expansion coefficient of the silicon carbide is 3.9×10⁻⁶/K. It is known that iron-nickel-based alloys such as Invar, which combines iron and nickel, and Super Invar, which combines iron, nickel and cobalt, can be cast, but the thermal expansion coefficients can be specifically suppressed because of cancellation of the expansion of the interatomic distance and the contraction of the atomic radius. However, since the thermal expansion coefficients are smaller than that of the glass to be formed, Invar and the like cannot be used in the temperature range of 500 to 700° C.

Ceramics based on metal oxides such as alumina and zirconia similarly have thermal expansion coefficients close to that of glass, which is a metal oxide. However, the processing of ceramics is difficult. In addition, since the ceramic has hydroxyl groups on its surface, it is easy to bond between metal oxides and has poor die releasability. Therefore, a special die material is used for the die D1 according to the present embodiment. A die made of cermet or other ceramic material is also referred to as a die.

Materials of the die D1 according to the present embodiment include the following. However, the materials are not limited to these:
Cemented carbide having a large thermal expansion coefficient obtained by increasing a binder, or cermet having a large thermal expansion coefficient (JP 2016-125073 A and JP 2017-206403 A)
Ceramics such as metal oxides, nitrides, borides, silicides or the like,
Material with a thermal expansion coefficient adjusted by dispersion of Fluorophlogopite mica crystals into a glass matrix,
Platinum-group or platinum-group alloy having a thermal expansion coefficient close to Soda-Lime glass alone, and chromium or Chromium-Containing alloy
Molybdenum-containing alloy in which iron having a large thermal expansion coefficient is combined with metal having a small coefficient of thermal expansion, tungsten-containing alloy in this combination, or the like.

Concrete examples of these are followings: WC-40% CO cemented carbide made by Fuji Die Co., Ltd., chromium carbide base alloy made by Fuji Die Co., Ltd., KF alloy made by Fuji Die Co., Ltd., Incoloy 909, HRA 929 made by Hitachi Metals, chromium silicide, macellite made by Krosaki Harima Corporation, or the like.

Further, in the pressing step according to the present embodiment, it is preferable to press with a die D1 having high die releasability on the contact surface of the die D1 with the plate glasses 21 and 22 or a die D1 processed with surface treatment for enhancing the die releasability.

In the conventional reheat molding (reheat press method), it is known that the die releasability deteriorates as the pressure of pressing increases and as the contact time between the die and the glass material increases. Therefore, in the conventional reheat molding, when a small glass member is manufactured, a sufficient difference in thermal expansion coefficient is secured between the die and the glass material to prevent sticking of the die and the glass material. On the other hand, in the manufacturing method of the large plate glasses 21 and 22 according to the present embodiment, the difference in thermal expansion coefficient is small. Therefore, there is a concern that the plate glasses 21 and 22 are easy to stick to the die D1. In particular, in the case of manufacturing the large plate glasses 21 and 22, heating and cooling are performed more slowly than in the case of manufacturing the small plate glasses, so that there is a concern that the sticking is further promoted.

Therefore, in the present embodiment, the contact angle between the molten glass and the surface of the die D1 is preferably 70 degrees or more, and more preferably 90 degrees or more. When the base material of the die D1 is subjected to the surface treatment, the thermal expansion coefficient of the surface treatment is preferably 2.0×10⁻⁶/K or less different from the thermal expansion coefficients of the plate glasses 21 and 22 and the base material of the die D1. In this way, by pressing with the die D1 having high die releasability or processed with surface treatment for enhancing the die releasability, the sticking problem is solved, and the plate glasses 21 and 22 can be easily removed from the die D1.

Specifically, the surface treatment is, for example, as follows:
Platinum group based plating or gold alloy plating having specifically poor wettability of molten glass and little possibility of sticking (see JP 2001-278631 A)
Plating treatment such as hard gold plating or chrome plating
Deposition treatment of Chromium-Based alloy
Formation of superhard films such as metal nitrides, borides, carbides, and silicides

Platinum group metals are known to be less wettable to molten glass. For example, platinum and rhodium alone have (cause) contact angles of more than 70 degrees. A small amount of gold may be added to these platinum group metals. The contact angle can be further increased by adding gold. It is known that gold alone has a contact angle of about 160 degrees. Therefore, gold alloy plating, which contains gold as a main component and has improved hardness or the like, may be used. It is preferable that the particle size of these metals is small as possible. By reducing the particle size, the hardness of the plating can be increased and the friction coefficient can be reduced. Amorphous plating can further increase hardness and reduce the friction coefficient.

When the material of the die D1 is chromium or a chromium-based alloy, plating treatment of chromium plating or vapor deposition treatment of the chromium-based alloy is preferable.

An example of a nitride is CrAlSiN. CrAlSiN has a contact angle of about 80 degrees. Other examples of nitrides are chromium nitride and chromium silicide. These have a contact angle of about 120 degrees or more (see JP 2007-84411 A). Alternatively, it may be a glass ceramic containing fluorophlogopite crystals or a molded product obtained by mixing a chromium compound with fluorophlogopite crystals. These are known to have low glass wettability (see JP H06-64937 A). Metallic chromium, chromium alloys, platinum, platinum alloys, chromium silicide, and glass ceramics containing fluorophlogopite mica crystals, and those formed by mixing chromium compounds in the above-mentioned glass ceramics are all particularly preferable since their thermal expansion coefficients are close to those of glass. These may be used as a die base material or as a thin film on a die surface formed by overlaying or surface treatment of a die made of a die base material having a suitable thermal expansion coefficient but poor releasability.

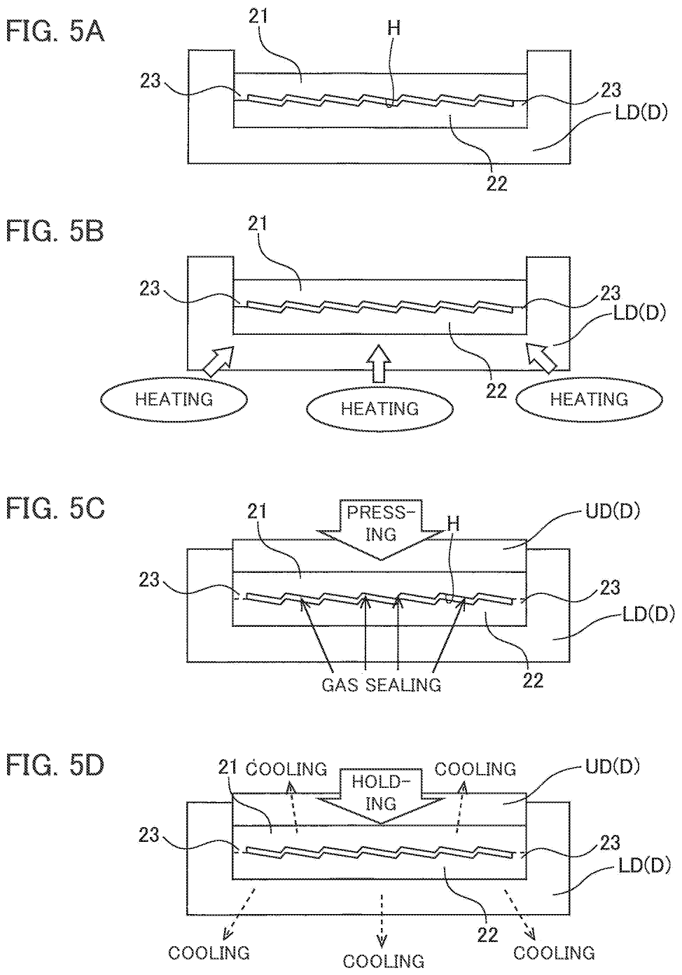

FIGS. 5A to 5D is a flow sheet showing a method of manufacturing the hollow glass 2 according to the second embodiment, wherein FIG. 5A shows a first step, FIG. 5B shows a second step, FIG. 5C shows a third step, and FIG. 5D shows a fourth step.

First, as shown in FIG. 5A, plate glasses 21 and 22 each having triangular prisms TP (see FIG. 3) and a frame glass 23 are stacked in a lower die LD (first step). One of the two plate glasses 21 and 22 further includes pillar glasses. By this stacking, a hollow portion H is formed between the plate glasses 21 and 22. Next, as shown in FIG. 5B, the plate glasses 21 and 22 stacked in the first step are heated (second step). In the second step, the plate glasses 21, 22 are heated to a temperature which is a softening point thereof or below and is a temperature or above at which the plate glasses 21, 22 can be diffusion-bonded at a predetermined pressure or higher.

Thereafter, as shown in FIG. 5C, the plate glasses 21 and 22 heated in the second step are pressed using the upper die (mold) UD by a predetermined pressure or higher (third step). The stacked plate glasses 21, 22 (especially, parts at the frame glasses 23) are diffusion-bonded and integrated.

Here, it is assumed that the pillar glasses are integrally formed on the plate glass 21 and the pillar glasses are not formed on the plate glass 22. When the pillar glasses integrally formed on the plate glass 21 are not to be diffusion-bonded to the plate glass 22, only the part of the frame glass 23 may be heated without uniformly heating the whole of the plate glasses 21, 22.

Also, same as the first embodiment, in the third step of the second embodiment, since the plate glasses 21 and 22 are soft, the hollow portion H tends to be crushed. Therefore, also in the third step of the present embodiment, a gas (e.g., an inert gas such as argon gas) is sealed (filled) in the hollow portion H. The sealing of the gas may be made together with pressing the plate glasses 21 and 22 or may be subsequently (successively) made after they are pressed.

Next, as shown in FIG. 5D, in the fourth step, the stacked plate glasses 21 and 22 are cooled to the strain point while being held with the die (mold) D. The cooling here is annealing by natural cooling. Thereafter, the hollow glass 2 is produced through a fifth step (see FIG. 2E). Same as the manufacturing method according to the first embodiment, the physically strengthened glass may be formed by removing the stress by annealing, followed by reheating and quenching.

According to the second embodiment, same as the first embodiment, it is possible to provide a hollow glass and a manufacturing method of the hollow glass, which are capable of suppressing an increase of the cost and improving the sealability of the hollow glass. In addition, it is possible to produce a heat-insulating vacuum glass by venting the gas sealed in the hollow portion H, which is for maintaining the shape of the hollow portion H, and evacuating the hollow portion H.

According to the second embodiment, the pillar glasses positioned in the hollow portion H are formed integrally with one of the plate glasses 21, 22 and protrudes toward the other of the plate glasses 21, 22. That is, the pillar glasses are integrated with at least one of the plate glasses 21 and 22. Therefore, it is possible to prevent the pillar glasses from falling off from the hollow glass 2. A plate glass provided with the pillar glasses and a plate glass not provided with the pillar glasses are stacked each other. Therefore, it is not necessary to regularly arrange the pillar glasses between the plate glasses 21 and 22.

Next, a third embodiment according to the present invention will be described. The hollow glass according to the third embodiment and the method of manufacturing the same are partially different from those of the first embodiment in structure and method. In other words, the configuration and steps according to the third embodiment are the same as those of the first embodiment except for differences from the first embodiment. The difference from the first embodiment will be described below.

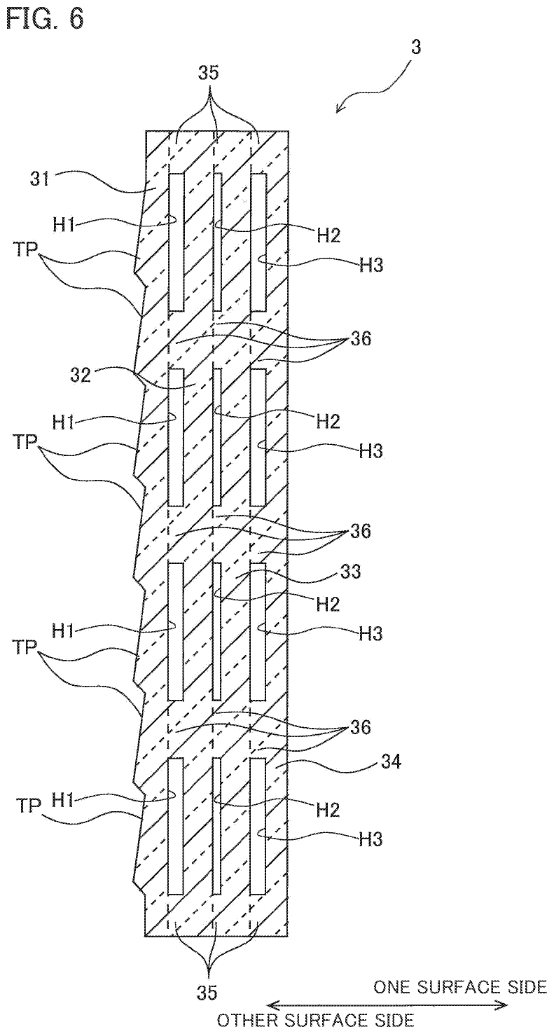

FIG. 6 is a cross-sectional view showing an example of a hollow glass 3 according to the third embodiment. As shown in FIG. 6, the hollow glass 3 includes four plate glasses 31 to 34. By integrating four plate glasses 31 to 34, the hollow glass 3 has 3 rows of hollow portions H1 to H3.

The first glass 31 is plate glass having a plane (flat surface) on one surface side and triangular prisms TP on the other surface side. Each of the second glass 32, the third glass 33 and the fourth glass 34 is a plate glass having planes on one surface side and the other surface side. The second glass 32, the third glass 33 and the fourth glass 34 are integrated with a frame glass 35 at their peripheral ends on the other surface sides. Similar to the first and second embodiments, the frame glass 35 forms an intermediate portion together with the plate glasses on both sides of the frame glass 35. One or more pillar glasses 36 are integrated with each of the second glass 32, the third glass 33 and the fourth glass 34. The pillar glasses 36 are positioned in an inner region surrounded by the frame glass 35.

In the hollow glass 3 according to the third embodiment, the hollow portion H2 of the second row is evacuated. That is, the hollow portion H2 of the second row forms a vacuum heat insulating portion.

The hollow portions H1 and H3 of the first and third rows are mutually connected (communicated) by a connecting pipe (not shown) to form a circulation passage for refrigerant. For example, when a temperature on one surface side of the hollow glass 3 is higher than that on the other surface side, heat on the one surface side is released to the other surface side by the circulation of the refrigerant

The above example will be described. The circulation passage is filled with a refrigerant, and the hollow portion H3 functions as an evaporator of the refrigerant. When one surface side of the fourth glass 34 receives heat, the liquid refrigerant in the hollow portion H3 is evaporated. By this evaporation, the heat transmitted from the one surface side of the fourth glass 34 is taken away by the refrigerant. The vapor of the refrigerant moves to the hollow portion H1 through the connecting pipe (not shown).

On the other hand, the hollow portion H1 has been cooled by outside air on the other surface side of the first glass 31. Therefore, the hollow portion H1 functions as a refrigerant condenser. That is, the vapor of the refrigerant from the hollow portion H3 is condensed in the hollow portion H1. This heat of condensation is discharged (released) from the other side of the first glass 31 (so-called heat radiation).

As described above, in the hollow glass 3, it is possible to release heat on one surface side to the other surface side when a temperature on the one surface side is higher than that on the other surface side, by the circulation of the refrigerant. Here, when the temperature on the other surface side of the hollow glass 3 is higher than that on the one surface side, heat is insulated by the hollow portion H2, and heat transmission from the other surface side to the one surface side can be suppressed.

Further, the hollow glass 3 includes the triangular prisms TP formed on the other surface side of the first glass 31. Similar to the triangular prisms TP according to the second embodiment, the triangular prisms TP are appropriately coated with ceramic paint depending on the application, and take in or reflects sunlight depending on the condition of installation state, the altitude of the sun, or the like.

The first to fourth glasses 31 to 34 can be formed with high accuracy by the method described with reference to FIG. 4.

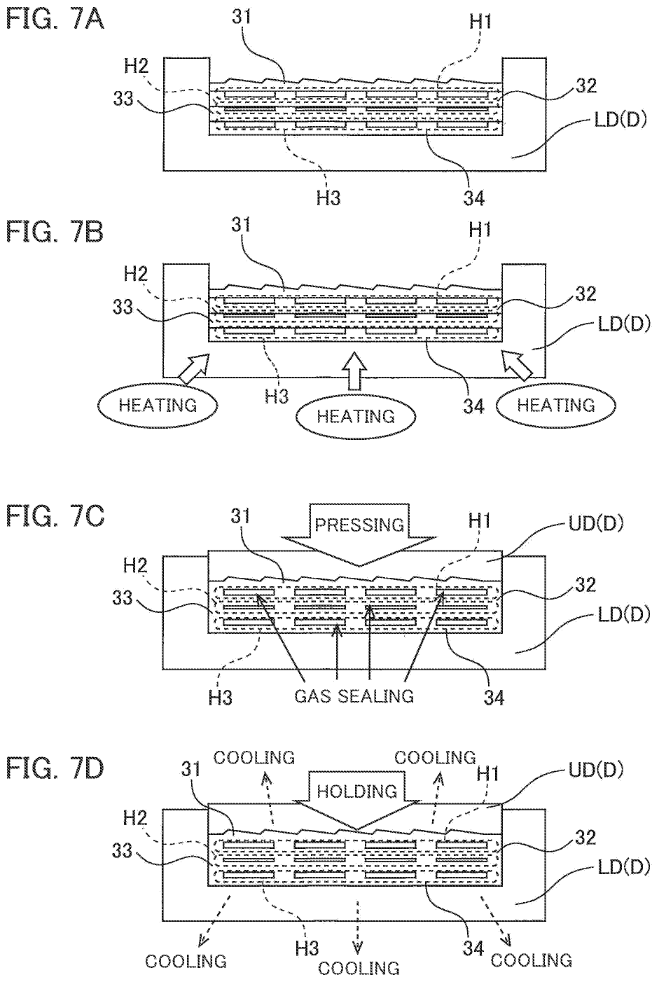

FIGS. 7A to 7D are a flow sheet showing a method of manufacturing the hollow glass 3 according to the third embodiment, wherein FIG. 7A shows a first step, FIG. 7B shows a second step, FIG. 7C shows a third step, and FIG. 7D shows a fourth step.

First, as shown in FIG. 7A, the second to fourth glasses 32 to 34 each having the frame glass 35 (see FIG. 6) and the pillar glasses 36 (see FIG. 6) are stacked in the lower die LD. Further, the first glass 31 having triangular prisms TP (see FIG. 6) is stacked (first step). By this stacking, the hollow portions H1 to H3 are formed between adjacent two of the glasses 31 to 34. Next, as shown in FIG. 7B, the stacked first to fourth glasses 31 to 34 are heated (second step). In the second step, the first to fourth glasses 31 to 34 are heated to a temperature which is a softening point thereof or below and is a temperature or above at which the first to fourth glasses 31 to 34 can be diffusion-bonded at a predetermined pressure or higher.

Thereafter, as shown in FIG. 7C, the first to fourth glasses 31 to 34 heated in the second step are pressed using the upper die (mold) UD by a predetermined pressure or higher (third step). The stacked first to fourth glasses 31 to 34 (particularly, the frame glass 35 and the pillar glasses 36) are diffusion-bonded and integrated in the third step. Meanwhile, the pillar glasses 36 do not necessarily have to be bonded in the third step by heating only the frame glass 35 in the second step.

In the third step, the hollow portions H1 to H3 are sealed (filled) with a gas (for example, an inert gas such as argon gas). The sealing of the gas may be made together with pressing the first to fourth glasses 31 to 34 or may be subsequently (successively) made after they are pressed.

In the third embodiment, by stacking the first to fourth glasses 31 to 34, three rows of hollow portions H1 to H3 are formed vertically. With this reason, while pressing of the third step, due to the weight of the first to fourth glasses 31 to 34, the hollow portion H2 in the second row is more likely crushed than the hollow portion H1 in the first row, and the hollow portion H3 in the third row is more likely crushed than the hollow portion H2 in the second row, for example. Therefore, of the hollow portions H1 to H3, the lower the position is in the stacking direction, the higher the gas pressure to be set is at the time of sealing. That is, in the third embodiment, the gas pressure is set such that the pressure of the hollow portion H3 in the third row is higher than the pressure of the hollow portion H2 in the second row and the pressure of the hollow portion H2 is higher than the pressure of the hollow portion H1 in the first row. Specifically, the pressure of the hollow portion H1 is set to a value or higher capable of supporting the weight of the first glass 31. The pressure of the hollow portion H2 is set to a value or higher which is a sum of the pressure in the hollow portion H1 and a pressure capable of supporting the weight of the second glass 32. The pressure of the hollow portion H3 is set to a pressure or higher which is a sum of the pressure in the hollow portion H2 and a pressure capable of supporting the weight of the third glass 33.

Next, as shown in FIG. 7D, in the fourth step, the stacked first to fourth glasses 31 to 34 are cooled to the strain point while being held with the die (mold) D. The cooling here is annealing by natural cooling. Thereafter, the hollow glass 3 is produced through a fifth step (see FIG. 7E). Same as the manufacturing methods according to the first and second embodiments, the physically strengthened glass may be formed by removing the stress by annealing, followed by reheating and quenching.

As to the first glass 31, the triangular prisms TP may be formed by the first to fourth steps shown in FIG. 7 without undergoing the formation step of the triangular prism shown in FIG. 4. In the example shown in FIG. 7, the upper die UD has a die structure corresponding to the triangular prisms TP. Therefore, the triangular prisms TP may be formed on the surface of the first glass 31 by including the step (specifically, the pressing step) of forming the triangular prisms TP shown in FIG. 4 in the step (specifically, the third step) shown in FIG. 7. In this case, the pressure (internal pressure) applied to the hollow portion H1 in the pressing step shown in FIG. 7C may be set to, for example, about 2.5 MPa in the same manner as in the pressing step shown in FIG. 4C, and the pressure required for the diffusion bonding may be set to about 2.6 MPa by adding, for example, 0.1 MPa to the pressure of the press. The pressure in the hollow portion H2 is set slightly higher than the pressure in the hollow portion H1, and the pressure in the hollow portion H3 is set higher than the pressure in the hollow portion H2, as described above.

According to the third embodiment, same as the first and second embodiments, it is possible to provide a hollow glass and a manufacturing method of the hollow glass, which are capable of suppressing an increase of the cost and improving the sealability of the hollow glass. In addition, it is possible to produce a heat-insulating vacuum glass by venting the gas sealed in the hollow portions H1 to H3, which are for maintaining the shape of the hollow portions H1 to H3, and evacuating the hollow portions H1 to H3.

In the third embodiment, the four plate glasses 31 to 34 are stacked to form three rows of the hollow portions H1 to H3 arranged in the vertical direction. Of the three hollow portions H1 to H3, the lower the position is, the higher the pressure of the sealed gas to be set is. Accordingly, when the plate glasses to 34 are stacked into four layers, it is possible to appropriately maintain the shape of the lower hollow portions H1 to H3 which are easily crushed depending on the weight.

According to the third embodiment, same as the first and second embodiments, it is possible to prevent the pillar glasses 36 from falling off from the hollow glass 3.

Although the present invention has been described based on the embodiments described above, the present invention is not limited to the embodiments described above, and may be modified without departing from the scope of the present invention, or may be combined with known or well-known techniques as appropriate to the extent possible.

For example, in the example shown in FIG. 4, the die D1 is subjected to a surface treatment to enhance mold releasability. However, other means may be employed, such as making the flat glasses 21 and 22 easier to remove from the die D1 by blowing air without the surface treatment.

Further, the die D1 according to the second embodiment is subjected to surface treatment to enhance mold releasability in consideration of the difference between thermal expansion coefficients. However, these may be applied (considered) to the die D shown in FIGS. 2, 5 and 7.

Further, the first to fourth glasses 31 to 34 are stacked in the third embodiment. However, the present invention is not limited to this, and three, five or more plate glasses may be stacked.

The entire contents of Japanese Patent Application No. 2019-101029 (filed May 30, 2019) are incorporated herein by reference.

Although some embodiments of the present invention have been described above, these embodiments are presented as examples and are not intended to limit the scope of the invention. These new embodiments may be implemented in various other forms, and various omissions, substitutions, and modifications may be made without departing from the spirit and scope of the invention. These embodiments and modifications thereof are included in the scope and the gist of the invention and are included in the scope of the claimed invention and the equivalent thereof.

What is claimed is:

1. A method for manufacturing a hollow glass including a hollow portion inside, comprising:
a first step of stacking plate glasses of the same material each other to form the hollow portion between the plate glasses;
a second step of heating the stacked plate glasses to a temperature which is a softening point thereof or below and is a temperature or above at which the material can be diffusion-bonded at a predetermined pressure or higher;
a third step of pressing the heated and stacked plate glasses to a predetermined pressure or higher using a die together with or subsequently applying a gas pressure into the hollow portion by feeding gas into the hollow portion; and
a fourth step of cooling the stacked plate glasses to a strain point while the gas pressure is applied into the hollow portion and the stacked plate glasses are held with the die.

2. The method according to claim 1, wherein
the fourth step includes a fifth step of evacuating the hollow portion between the plate glasses having been cooled to the strain point.

3. The method according to claim 2, wherein
the first step includes stacking the plate glass one of which includes a pillar glass, and the pillar glass is positioned in the hollow portion, integrally formed with the one of the stacked plate glasses, and projects toward the other of the stacked plate glasses.

4. The method according to claim 2, wherein
the first step includes stacking, in the hollow portion, a pillar glass of the same material as the plate glasse, and
the third step includes diffusion bonding of the plate glasses and the pillar glass.

5. The method according to claim 1, wherein
the first step includes stacking of three or more plate glasses to form two or more rows of hollow portions arranged in a vertical direction, and
the third step includes setting gas pressures in the hollow portions, the gas pressure being made higher in the lower hollow portion of the two or more rows of the hollow portions.

6. The method according to claim 2, wherein
the first step includes stacking of three or more plate glasses to form two or more rows of hollow portions arranged in a vertical direction, and
the third step includes setting gas pressures in the hollow portions, the gas pressure being made higher in the lower hollow portion of the two or more rows of the hollow portions.

7. The method according to claim 3, wherein
the first step includes stacking of three or more plate glasses to form two or more rows of hollow portions arranged in a vertical direction, and
the third step includes setting gas pressures in the hollow portions, the gas pressure being made higher in the lower hollow portion of the two or more rows of the hollow portions.

8. The method according to claim 4, wherein
the first step includes stacking of three or more plate glasses to form two or more rows of hollow portions arranged in a vertical direction, and
the third step includes setting gas pressures in the hollow portions, the gas pressure being made higher in the lower hollow portion of the two or more rows of the hollow portions.

9. A hollow glass comprising:
at least two plate glasses; and
a frame glass having a bonding portion bonded with the at least two plate glasses to form a hollow portion between the at least two plate glasses, wherein
the at least two plate glasses and the frame glass are formed of the same material.

10. The hollow glass according to claim 9, wherein
at least one of the two plate glasses forming the hollow portion includes a pillar glass projecting toward the other of the two plate glasses, the pillar glass being joined or unjoined to the other of the two plate glasses, and
the pillar glass is formed of the same material as the at least two plate glasses and the frame glass.
